(19) United States
(12) Patent Application Publication
(10) Pub. No.: US 2025/0240110 A1
(43) Pub. Date: Jul. 24, 2025

(54) PPS synchronization with delay correction

(71) Applicant: Mellanox Technologies, Ltd., Yokneam (IL)

(72) Inventors: Natan Manevich, Nesher (IL); Dotan David Levi, Kiryat Motzkin (IL); Bar Shapira, Tel Aviv (IL); Wojciech Wasko, Mlynek (PL); Maciej Machnikowski, Reda (PL); Oren Matus, Kfar Yehezkel (IL); Yam Gellis, Tel Aviv (IL)

(21) Appl. No.: 18/418,276

(22) Filed: Jan. 21, 2024

(51) Int. Cl. H04J 3/06

(52) U.S. Cl. CPC H04J 3/0661; H04J 3/0673

(57) ABSTRACT

In one embodiments, a first device includes a first n-pulse-per-second (nPPS) output interface to be connected to a second nPPS input interface of a second device via a first clock connection, and to send a first pulse at time A to the second nPPS input interface for receipt at time B, and a first nPPS input interface to be connected to a second nPPS output interface of the second device via a second clock connection, to receive a second pulse at time D from the second nPPS output interface sent at time C, and to log time D in a first memory, and delay computation circuitry to compute a clock connection delay in the first clock connection and/or the second clock connection based on time A, time D, and a time difference between receiving the first pulse in, and sending the second pulse from, the second device.

### FIELD OF THE INVENTION

The present invention relates to computer systems, and in particular, but not exclusively to, clock synchronization.

### BACKGROUND

A pulse per second (PPS) signal is used for precise time synchronization between multiple devices in a network. The signal is usually generated by a highly accurate clock, such as a GPS or atomic clock, and transmitted to other devices in the network. The receiving devices then use the received PPS signal as a reference to synchronize their own clocks to the precise time. This is important for applications that require accurate timestamping, such as financial transactions, scientific experiments, and telecommunication systems.

Pulse Per Second (PPS) source and destination systems are usually connected to each other through a cable. The propagation delay of the PPS signal has to be taken into consideration in order to achieve accurate time synchronization using this method. Propagation delay is the amount of time it takes for the signal to travel from the source to the destination, and it may vary according to the length of the cable, the type of cable, the connectors which are used, and other factors, such as the ambient temperature. If the propagation delay is unknown, it may lead to a time offset between the source and destination, resulting in inaccurate time synchronization.

### SUMMARY

There is provided in accordance with an embodiment of the present disclosure, a system, including a first device including a first clock to maintain a first clock time, a first n-pulse-per-second (nPPS) output interface to be connected to a second nPPS input interface of a second device via a first clock connection, and to send a first pulse at a time There is also provided in accordance with still another embodiment of the present disclosure a to the second nPPS input interface for receipt by the second nPPS input interface at a time B, and a first nPPS input interface to be connected to a second nPPS output interface of the second device via a second clock connection, to receive a second pulse at a time D from the second nPPS output interface sent by the second nPPS output interface at a time C, and to log the time D in a first memory, and delay computation circuitry to compute a clock connection delay in at least one of the first clock connection or the second clock connection based on the time There is also provided in accordance with still another embodiment of the present disclosure a, the time D, and a time difference between receiving the first pulse in the second device and sending the second pulse from the second device.

Further in accordance with an embodiment of the present disclosure, the system includes clock synchronization circuitry to discipline the first clock of the first device, or a second clock of the second device, responsively to a pulse received by the first device or the second device, respectively, and the computed clock connection delay.

Still further in accordance with an embodiment of the present disclosure the delay computation circuitry is to compute the time difference between receiving the first pulse in the second device and sending the second pulse from the second device based on the time B and the time C.

Additionally in accordance with an embodiment of the present disclosure the time difference between receiving the first pulse in the second device and sending the second pulse from the second device is computed based on the time B and the time C, the delay computation circuitry being to receive the computed time difference from the second device.

Moreover in accordance with an embodiment of the present disclosure the time difference between receiving the first pulse in the second device and sending the second pulse from the second device is a predetermined time delay based on a hardware configuration of the second device, the delay computation circuitry being to compute the clock connection delay based on the time There is also provided in accordance with still another embodiment of the present disclosure a, the time D, and the predetermined time delay.

Further in accordance with an embodiment of the present disclosure the predetermined time delay is equal to a single clock cycle of a controller of the second device.

Still further in accordance with an embodiment of the present disclosure the delay computation circuitry is to repeat the computation of the clock connection delay intermittently yielding multiple clock connection delay results based on other pulses sent by the first device and the second device.

Additionally in accordance with an embodiment of the present disclosure the delay computation circuitry is to compute an average of the multiple clock connection delay results.

Moreover in accordance with an embodiment of the present disclosure the first nPPS output interface is to periodically send clock synchronization pulses at a rate of n pulses per second to the second nPPS input interface via the first clock connection, and the first nPPS output interface is to send, among at least two of the clock synchronization pulses, third pulses of the other pulses, at a rate of m pulses per second, used to yield the multiple clock connection delay results.

Further in accordance with an embodiment of the present disclosure the first nPPS output interface is to periodically send clock synchronization pulses at a rate of n pulses per second to the second nPPS input interface via the first clock connection, and the first nPPS output interface is to send the first pulse at the time There is also provided in accordance with still another embodiment of the present disclosure a between two of the clock synchronization pulses.

Still further in accordance with an embodiment of the present disclosure the delay computation circuitry is to derive the time There is also provided in accordance with still another embodiment of the present disclosure a from the time D.

Additionally in accordance with an embodiment of the present disclosure, the system includes the first clock connection, the second clock connection, and the second device, wherein the second nPPS input interface is to receive the first pulse at the time B, and log the time B in a second memory, and the second nPPS output interface is to send the second pulse to the first device via the second clock connection.

Moreover in accordance with an embodiment of the present disclosure, the system includes the second device, wherein the second nPPS input interface is to receive the first pulse at the time B, and log the time B in a second memory, the second device includes a controller to detect receipt of the first pulse and cause the second nPPS output interface to send the second pulse to the first device via the second clock connection in response to detecting the receipt of the first pulse, and the second nPPS output interface is to log the time C in the second memory.

Further in accordance with an embodiment of the present disclosure the controller is to minimize a difference between time B and time C.

Still further in accordance with an embodiment of the present disclosure, the system includes the second device, wherein the second nPPS input interface is to receive the first pulse at the time B, and log the time B in a second memory, and the second device includes a controller to detect receipt of the first pulse and cause the second nPPS output interface to send the second pulse to the first device via the second clock connection within a predetermined time delay of detecting the receipt of the first pulse.

Additionally in accordance with an embodiment of the present disclosure the predetermined time delay is equal to a single clock cycle of the controller.

Moreover, in accordance with an embodiment of the present disclosure, the system includes the second device, wherein the second nPPS output interface is to send the second pulse at time C, which is before time B.

There is also provided in accordance with another embodiment of the present disclosure, a system, including a second device including a second n-pulse-per-second (nPPS) input interface to be connected to a first nPPS output interface of a first device via a first clock connection, to receive a first pulse at a time B from the first nPPS output interface sent by the first nPPS output interface at a time There is also provided in accordance with still another embodiment of the present disclosure a, and to log the time B in a second memory, a second nPPS output interface to be connected to a first nPPS input interface of the first device via a second clock connection, and to send a second pulse at a time C to the first nPPS input interface for receipt by the first nPPS input interface at a time D, and a controller to detect receipt of the first pulse and cause the second nPPS output interface to send the second pulse to the first device via the second clock connection in response to detecting the receipt of the first pulse.

Further in accordance with an embodiment of the present disclosure, the system includes delay computation circuitry to compute a clock connection delay in at least one of the first clock connection or the second clock connection based on the time There is also provided in accordance with still another embodiment of the present disclosure a, the time D, and a time difference between receiving the first pulse in the second device and sending the second pulse from the second device, and clock synchronization circuitry to discipline a first clock of the first device, or a second clock of the second device, responsively to a pulse received by the first device or the second device, respectively, and the computed clock connection delay.

Still further in accordance with an embodiment of the present disclosure the delay computation circuitry is to compute the time difference between receiving the first pulse in the second device and sending the second pulse from the second device based on the time B and the time C.

Additionally in accordance with an embodiment of the present disclosure the time difference between receiving the first pulse in the second device and sending the second pulse from the second device is computed based on the time B and the time C, the delay computation circuitry being to receive the computed time difference.

Moreover, in accordance with an embodiment of the present disclosure the controller is to cause the second nPPS output interface to send the second pulse to the first device via the second clock connection within a predetermined time delay of detecting the receipt of the first pulse.

Further in accordance with an embodiment of the present disclosure the predetermined time delay is equal to a single clock cycle of the controller.

Still further in accordance with an embodiment of the present disclosure the controller is to minimize a difference between time B and time C.

There is also provided in accordance with still another embodiment of the present disclosure, a method, including connecting a first n-pulse-per-second (nPPS) output interface of a first device to a second nPPS input interface of a second device via a first clock connection, connecting a first nPPS input interface of the first device to a second nPPS output interface of the second device via a second clock connection, sending a first pulse at a time There is also provided in accordance with still another embodiment of the present disclosure a from the first nPPS output interface to the second nPPS input interface for receipt by the second nPPS input interface at a time B, receiving a second pulse at a time D by the first nPPS input interface from the second nPPS output interface sent by the second nPPS output interface at a time C, logging the time D in a first memory, and computing a clock connection delay in at least one of the first clock connection or the second clock connection based on the time There is also provided in accordance with still another embodiment of the present disclosure a, the time D, and a time difference between receiving the first pulse in the second device and sending the second pulse from the second device.

There is also provided in accordance with still another embodiment of the present disclosure, a method, including connecting a first n-pulse-per-second (nPPS) output interface of a first device to a second nPPS input interface of a second device via a first clock connection, connecting a first nPPS input interface of the first device to a second nPPS output interface of the second device via a second clock connection, receiving by the second nPPS input interface a first pulse at a time B from the first nPPS output interface sent by the first nPPS output interface at a time There is also provided in accordance with still another embodiment of the present disclosure a, logging the time B in a second memory, detecting receipt of the first pulse, and causing the second nPPS output interface to send a second pulse to the first device via the second clock connection in response to detecting the receipt of the first pulse, and sending the second pulse at a time C from the second nPPS output interface to the first nPPS input interface for receipt by the first nPPS input interface at a time D.

### BRIEF DESCRIPTION OF THE DRAWINGS

The present invention will be understood from the following detailed description, taken in conjunction with the drawings in which:

FIG. 1 is a block diagram view of a time synchronization system constructed and operative in accordance with an embodiment of the present invention;

FIG. 2 is a flowchart including steps in a method of operation of the system of FIG. 1;

FIG. 3 is a first pulse flow diagram showing pulses being sent in the system of FIG. 1;

FIG. 4 is a second pulse flow diagram showing pulses being sent in the system of FIG. 1; and

FIG. 5 is a third pulse flow diagram showing pulses being sent in the system of FIG. 1.

### DESCRIPTION OF EXAMPLE EMBODIMENTS

### Overview

In order to ensure accurate time synchronization, the propagation delay of the PPS signal in the cable or connection between the two devices must be considered and compensated for. The compensation for the propagation delay can be performed, for example, in software. The propagation delay of the PPS signal can be estimated using the length of the cable through which it is transmitted. The longer the cable, the longer it takes for the PPS signal to travel from the source to the destination, resulting in a greater propagation delay. For example, by using a common rule of thumb of 5 nanoseconds delay for every 1 meter of cable. This may also be performed by directly measuring the delay using specialized equipment.

Modern computer systems may require very high accuracy synchronization, which may approach a few nanoseconds or even sub-nanoseconds accuracy. The methods described above may not be accurate enough for achieving those accuracy levels.

Estimating propagation delay from cable length may be inaccurate. The calculation does not consider the propagation delay inside the connectors at both ends of the cable, and assumes a very specific propagation speed, e.g., 5 nanoseconds per meter rule of thumb, which in reality can vary. For example, cable material, cable width, and ambient temperature may affect propagation speed in the cable.

Using dedicated test equipment to measure the propagation delay may provide an accurate measurement for a specific cable. The measured value may not be valid for cables from different vendors, even if those cables have the same length, and may vary for the same cable (with the same part number) due to variations in length. The measurement is also valid for a specific working point. The actual propagation delay may, for example, vary with temperature.

Embodiments of the present invention address at least some of the above drawbacks by providing a system which dynamically and accurately measures propagation delay of a PPS signal between two devices (such as device A and device B). Device A and device B are connected to each other in both directions with PPS connections. A PPS output interface of device A is connected to a PPS input interface of device B using a first connection, and a PPS output interface of device B is connected to a PPS input interface of device A using a second connection. It assumed that the first connection and second connection are very similar or the same (e.g., have the same part number). For example, device A sends a first pulse to device B via the first connection at time A. Upon receipt of the first pulse in device B at time B, device B sends a second pulse to device B via the second connection at time C. The second pulse is received in device B at time D. Delay computation circuitry in device A or device B or in any suitable device may compute the delay in one of the cables based on half of: time D less time A less the delay in device B (between receiving the first pulse in device B and sending the second pulse to device A), which is generally equal to time C less time B. It should be noted that time A and D are according to the local clock of device A, and times B and C are according to the local clock of device B.

Times A-D may be logged by the relevant devices in local memory and passed to the delay computation circuitry, for example, by software, in the corresponding devices. The logging entity may also send an interrupt signal to the local software thereby informing the software about the logged event. Timing data may be sent between the devices via a network connection or via a peripheral communication data bus, for example.

In some embodiments, Time A may be derived from time D, for example, if the first pulse is sent periodically, e.g., on the second. In some embodiments, times B and C are logged by device B in local memory. In other embodiments, the delay in device B may be logged by device B or the delay may be predetermined. For example, in some embodiments, the hardware configuration of device B is arranged so that the delay in device B is predetermined (e.g., fixed, or configurable).

Device A and device B may include functionality for sending pulses from their respective PPS output interfaces periodically, e.g., on the second. The PPS output interfaces may send a periodic signal according to nPPS, where n is any suitable integer. Therefore, the PPS output interfaces may send one pulse per second or n pulses per second. Embodiments of the present invention may allow devices A and/or B to send pulses on the fly, e.g., not on the periodic PPS schedule. Due to various factors, for example, the clocks of device A and device B running at slightly different rates, it may be important to minimize the delay in device B (i.e., the delay between times B and C) as much as possible. Therefore, in some embodiments, when device B receives the first pulse, the first pulse is detected by a controller of device B, and the controller causes the PPS output interface of device B to send the second pulse to device A, generally as quickly as possible, for example, in one clock cycle of the controller.

The reasons for minimizing the delay in device B are now described in more detail below. As mentioned above, the devices may theoretically run with different frequencies relative to each other. For example, in case each one of the devices is fed by its own local oscillator with a frequency accuracy of 50 parts per million (PPM) versus a nominal value, both oscillators can drift up to 100 PPM one from another, which means that every second can result in a drift of up to 100 microseconds. This means that (time D less time A) and (time C less time B) correspond to different time scales. For example, one second passing on device A will not necessarily be equal to 1 second passing on device 2, and both times will not necessarily be equal to a “real” and nominal 1 second.

Even in cases where the frequencies of the devices are synchronized to each other, for example using a PPS pulse, the devices may still rely on a local oscillator in the short term, and a momentary frequency jitter may occur, for example due to a temperature fluctuation near device B. Such jitter may result in accumulation of a time error between time B and time C, which would negatively affect the measurement of the delay in the clock connection between device A and B. If this time (time C less time B) is short, for example in the nanosecond range, the accumulated error throughout this time will be negligible. For example, if the frequency accuracy is 100 PPM and time C less time B is equal to ten nanoseconds, the maximum time error which can be accumulated throughout this time would be 100 microseconds (i.e., the maximum drift in 1 second) divided by 100,000,000 (10 nanoseconds relative to 1 second) giving 1 picosecond. Therefore, it is important to minimize the difference between time B and time C, for example, using the controller described above.

The measurement of the delay in the clock connection may be repeated intermittently to account for changes such as temperature variability and aging. Additionally, or alternatively, multiple pulses may be sent from device A to device B and multiple return pulses may be sent from device B to device A. The delay computation circuitry may compute an average delay in the connection based on the timing of these pulses. If both devices are able to send pulses on-the-fly (e.g., not on the periodic schedule of the PPS output interfaces), device A may send one or more pulses between the regular periodic (e.g., on the second) pulses, and compute an average delay in the connection between the devices based on the pulses sent and the pulses received.

If device A cannot send pulses on the fly, device A may then send a pulse according to the regular PPS periodic schedule (e.g., on the second) and device B returns the second pulse in response to detecting receipt of the first pulse. In such cases, device A may not be able to log time A of the first pulse departing device A. However, assuming the delay in the clock connection is short enough (e.g., a lot less than one second), when the second pulse is received by device A, device A logs time D, and time A may be derived from time D by rounding down to the nearest second, for example, or to any suitable time value based on the regular PPS periodic schedule.

In some embodiments, both devices may be unable to send PPS pulses on the fly and can only send pulses according to the regular PPS schedule. In such a case, device A and device B may each send a pulse at time A and time C, respectively, according to the PPS schedule (e.g., on the second) for receipt by device B and device A at time B and time D, respectively. In such a case, the delay computation circuitry may compute the delay in the connection between device A and device B as previously described above.

### System Description

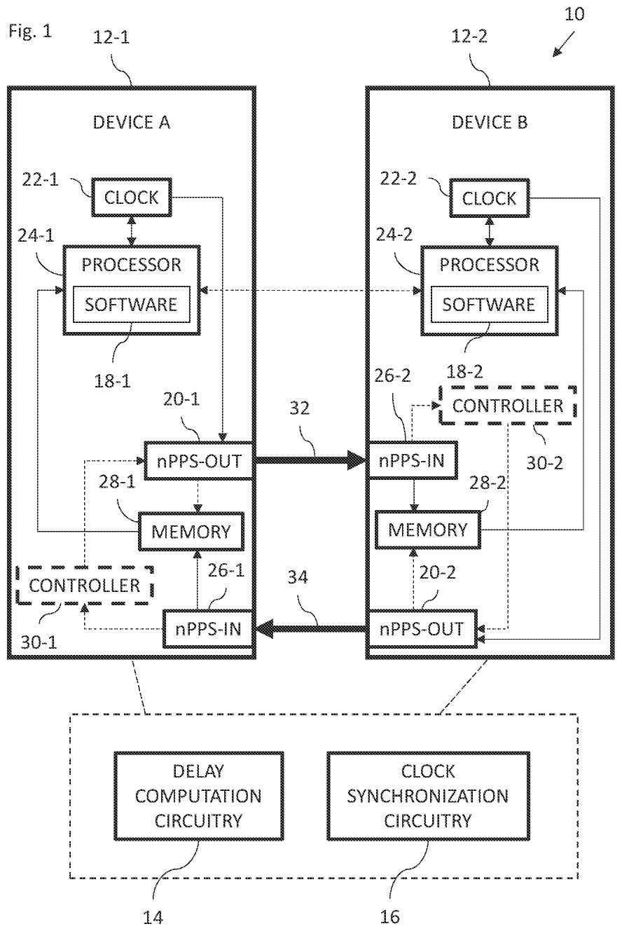

Reference is now made to FIG. 1, which is a block diagram view of a time synchronization system 10 constructed and operative in accordance with an embodiment of the present invention.

The system 10 includes two devices 12, also referred to as device A or device 12-1 and device B or device 12-2. The system 10 also includes delay computation circuitry 14 and clock synchronization circuitry 16. The delay computation circuitry 14 may be comprised in one or more of the devices 12 and/or in a third entity (not shown). The clock synchronization circuitry 16 may be comprised in one or more of the devices 12 and/or in another entity (not shown). For example, the functionality of the delay computation circuitry 14 and/or the clock synchronization circuitry 16 may be performed by software 18 running on one or more of the devices 12, as described in more detail below.

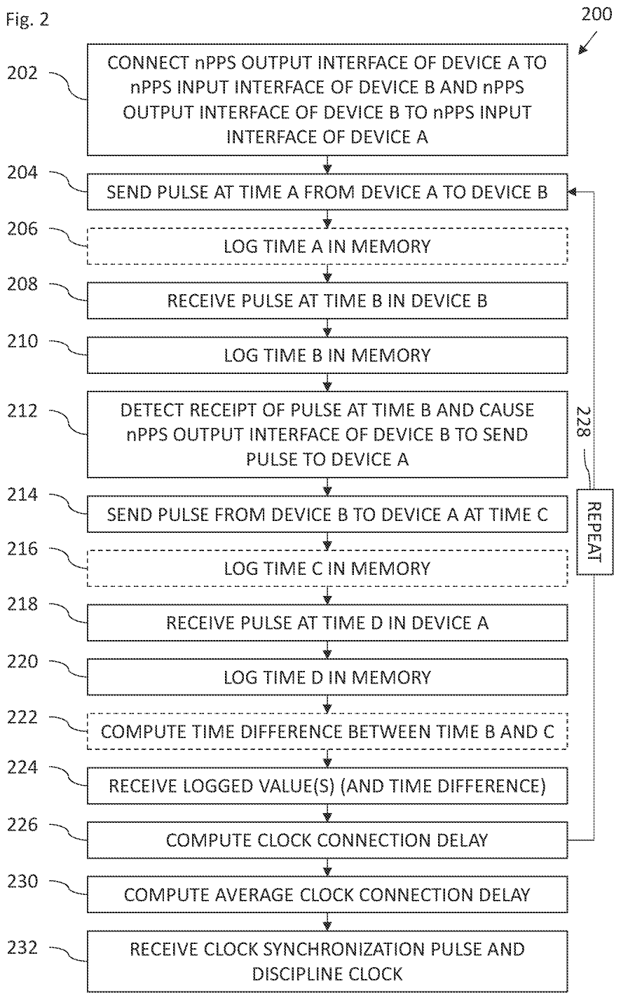

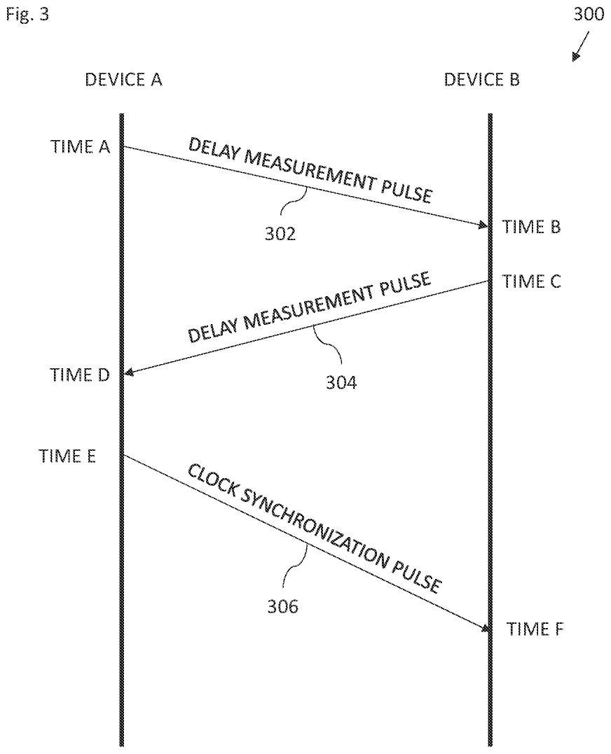

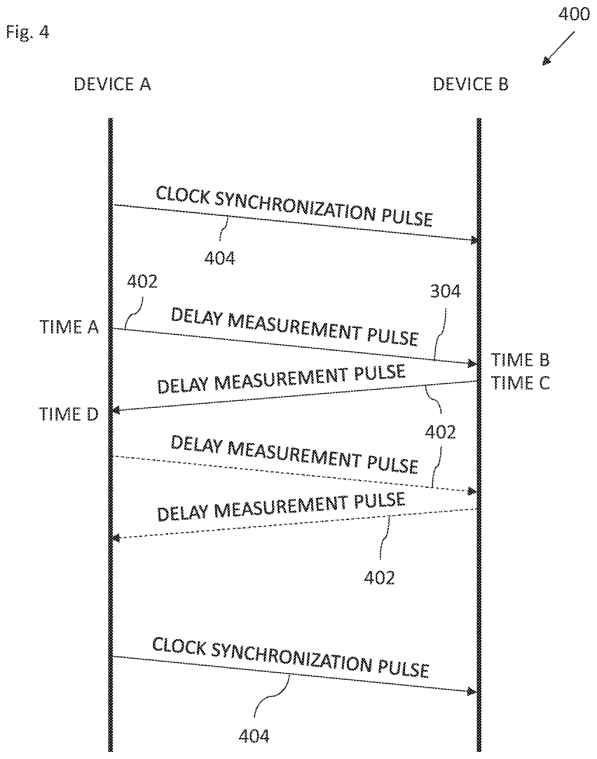

Device 12-1 includes: a clock 22-1 configured to maintain a clock time; a processor 24-1 configured to run software 18-1; an n pulse per second nPPS output interface 20-1 to send pulses to another device (e.g., to device 12-2); an nPPS input interface 26-1 to receive pulses from another device (e.g., from device 12-2); a memory 28-1 in which the nPPS input interface 26-1, and optionally the nPPS output interface 20-1, may log arrival times, and sent times, respectively, of pulses; and optionally a controller 30-1. The nPPS output interface 20-1 may be configured to output pulses periodically at a rate of n pulses per second, e.g., one per second on the second, or multiple pulses per second, according to the time maintained by the clock 22-1. In some embodiments, the nPPS output interface 20-1 may be configured to output a pulse or pulses on the fly according to any suitable timing or schedule, for example, based on a command from the software 18-1, as described in more detail with reference to FIGS. 3 and 4. In some embodiments, the nPPS output interface 20-1 is configured to log the sent times of the pulses in the memory 28-1 in response to being configured to do so, for example, based on a command from software 18-1. The nPPS input interface 26-1 is configured to receive pulses from another device (e.g., from device 12-2) and may be configured to log arrival times in the memory 28-1 in response to being configured to do so, for example, based on a command from software 18-1. The controller 30-1 may be configured, based on a command from software 18-1, to detect receipt of a pulse by the nPPS input interface 26-1 and cause the nPPS output interface 20-1 to send a pulse based on the detected receipt of the pulse, as described in more detail with reference to FIGS. 2 and 3.

Device 12-2 includes: a clock 22-2 configured to maintain a clock time; a processor 24-2 configured to run software 18-2; an n pulse per second nPPS output interface 20-2 to send pulses to another device (e.g., to device 12-1); an nPPS input interface 26-2 to receive pulses from another device (e.g., from device 12-1); a memory 28-2 in which the nPPS input interface 26-2, and optionally the nPPS output interface 20-2, may log arrival times, and sent times, respectively, of pulses; and optionally a controller 30-2. The nPPS output interface 20-2 may be configured to output pulses periodically at a rate of n pulses per second, e.g., one per second on the second, or multiple pulses per second, according to the time maintained by the clock 22. In some embodiments, the nPPS output interface 20-2 may be configured to output a pulse or pulses on the fly according to any suitable timing or schedule, for example, based on a command from the software 18-2, as described in more detail with reference to FIGS. 3 and 4. In some embodiments, the nPPS output interface 20-2 is configured to log sent times of the pulses in the memory 28-2 in response to being configured to do so, for example, based on a command from software 18-2. The nPPS input interface 26-2 is configured to receive pulses from another device (e.g., from device 12-2) and may be configured to log arrival times in the memory 28-2 in response to being configured to do so, for example, based on a command from software 18-2. The controller 30-2 may be configured, based on a command from software 18-2, to detect receipt of a pulse by the nPPS input interface 26-2 and cause the nPPS output interface 20-2 to send a pulse based on the detected receipt of the pulse, as described in more detail with reference to FIGS. 2 and 3.

The nPPS output interface 20-1 of the device 12-1 is configured to be connected to the nPPS input interface 26-2 of the device 12-2 via a clock connection 32 (e.g., clock cable). The nPPS output interface 20-2 of the device 12-2 is configured to be connected to the nPPS input interface 26-1 of the device 12-1 via a clock connection 34 (e.g., clock cable). The delay computation circuitry 14 is configured to compute the delay in the clock connection 32 and/or the clock connection 34 based on timing of pulses sent by devices 12, as described in more detail with reference to FIGS. 2-5.

In some embodiments, one of the controllers 30-1, 30-2 is configured to detect receipt of a pulse by the nPPS input interface 26-1, 26-2 and cause the nPPS output interface 20-1, 20-2 to send a pulse based on the detected receipt of the pulse, respectively, depending on which one of the devices 12 initiates the pulses used to compute delay in the clock connection 32 and/or the clock connection 34, as described in more detail with reference to FIGS. 3 and 4.

The clock synchronization circuitry 16 is configured to discipline the clock 22-1 of the device 12-1 and/or the clock 22-2 of the device 12-2, responsively to a pulse (or pulses) received by the device 12-1 and/or the device 12-2, respectively, and the computed clock connection delay. For example, if device 12-1 sends a pulse on the round second to device 12-2 according to clock 22-1 and the pulse is received by device 12-2 at time F (e.g., 12 nanoseconds after the round second according to the clock 12-2), the clock synchronization circuitry 16 is configured to compute a clock adjustment based on the computed delay in the clock connection 32 of X (e.g., 5 nanoseconds) so that the time maintained by clock 22-2 is adjusted (e.g., reduced) by F less X (e.g., 7 nanoseconds).

Reference is now made to FIGS. 2 and 3. FIG. 2 is a flowchart 200 including steps in a method of operation of the system 10 of FIG. 1. FIG. 3 is a first pulse flow diagram 300 showing pulses being sent in the system 10 of FIG. 1. Reference is also made to FIG. 1.

The method includes connecting nPPS output interface 20-1 of device 12-1 to nPPS input interface 26-2 of device 12-2 via clock connection 32 and connecting nPPS input interface 26-1 of device 12-1 to nPPS output interface 20-2 of device 12-2 via clock connection 34 (block 202).

The nPPS output interface 20-1 of device 12-1 is configured to send a pulse 302 at time A to the nPPS input interface 26-2 of device 12-2 for receipt by nPPS input interface 26-2 at time B (block 204). In some embodiments, the nPPS output interface 20-1 is configured to log time A in memory 28-1 (block 206). In other embodiments, nPPS output interface 20-1 does not log time A. Time A may not be logged either where device 12-1 is incapable of logging time A or optionally where time A may be derived from another time such as time D, as described in more detail below. In embodiments where time A is not logged, the timing of sending pulse 302 may need to be chosen so that time A may be derived, e.g., by sending pulse 302 on the second or according to the periodic sending schedule of nPPS output interface 20-1 which is known to the device 12-1 or another entity that uses time A, as described in more detail below. The software 18-1 may configure nPPS output interface 20-1 to send the pulse 302 (or a series of pulses) either according to the periodic schedule of nPPS output interface 20-1 or on the fly (i.e., at times not according to the periodic schedule of nPPS output interface 20-1) and to log time A (if applicable).

The nPPS input interface 26-2 is configured to receive the pulse 302 at time B from the nPPS output interface 20-1 (block 208) and log time B in memory 28-2 (block 210). The software 18-2 may configure nPPS input interface 26-2 to log the times of received pulses in memory 28-2.

The controller 30-2 of device 12-2 is configured to detect receipt of the pulse 302 and cause the nPPS output interface 20-2 to send a pulse 304 (at time C) to device 12-1 via clock connection 34 in response to detecting the receipt of pulse 302 (block 212). In some embodiments, the controller 30-2 is configured to minimize a difference between time B and time C, as described in more detail below. In some embodiments, controller 30-2 is configured to detect receipt of pulse 302 and cause nPPS output interface 20-2 to send pulse 304 to device 12-1 via clock connection 34 within a predetermined time delay of detecting the receipt of pulse 302. Therefore, in some embodiments, the time difference between receiving pulse 302 in device 12-2 and sending pulse 304 from device 12-2 is a predetermined time delay (e.g., a fixed or a configurable time delay) based on a hardware configuration of the device 12-2 (e.g., a hardware configuration of the controller 30-2). In some embodiments, the predetermined time delay is equal to a single clock cycle of controller 30-2. The software 18-2 may configure the controller 30-2 to perform the above operations by commanding the controller 30-2 to detect received pulses and cause nPPS output interface 20-2 to send a return pulse to device 12-1. In some embodiments, the software 18-2 may configure the predetermined time delay of the controller 30-2.

The nPPS output interface 20-2 is configured to send pulse 304 at time C to nPPS input interface 26-1 for receipt by nPPS input interface 26-1 at time D (block 214). The software 18-2 may configure the nPPS output interface 20-2 to send a return pulse (or pulses) to device 12-2 triggered by controller 30-2.

In some embodiments, (i.e., when the time delay is not predetermined) nPPS output interface 20-2 (or the controller 30-2) is configured to log time C, or the difference between times B and C, in memory 28-2 (block 216). The software 18-2 may configure the nPPS output interface 20-2 or the controller 30-2 to log the time(s) of sent pulse(s) in the memory 28-2.

The nPPS input interface 26-1 is configured to receive pulse 304 at time D from the nPPS output interface 20-2 (block 218) and log time D in memory 28-1 (block 220). The software 18-1 may configure nPPS input interface 26-1 to log the time(s) of received pulse(s) in memory 28-1.

It should be noted that whenever times are logged to the memories 28-1, 28-2, the logging entity may send an interrupt to the software 18 running on the device 12 of the logging entity.

In some embodiments, the software 18-2 is configured to retrieve time B and C or the time difference between time B and C from memory 28-2 and provide the retrieved value(s) to the delay computation circuitry 14. The software 18-1 is configured to retrieve time D (and time A if stored) from memory 28-1 and provide the retrieved value(s) to the delay computation circuitry 14. As previously mentioned, the delay computation circuitry 14 may be disposed in device 12-1 or device 12-2 or another device. For example, the functionality of delay computation circuitry 14 may be performed by software 18-1 and/or software 18-2.

In some embodiments, the delay computation circuitry 14 is configured to compute the time difference between receiving pulse 302 in device 12-2 and sending pulse 304 from device 12-2 based on time B and time C (e.g., received from software 18-2 of device 12-2) (block 222). In some embodiments, device 12-2 (e.g., software 18-2) is configured to compute the time difference between receiving pulse 302 in device 12-2 and sending pulse 304 from device 12-2 based on time B and time C, and the delay computation circuitry 14 is configured to receive the computed time difference from device 12-2. In some embodiments, the delay computation circuitry 14 is configured to derive the time A from the time D. For example, if device 12-1 sends pulse 302 on the second, and time D is equal to 5 seconds and 20 nanoseconds, then time A is equal to 5 second and 0 nanoseconds.

The delay computation circuitry 14 is configured to receive logged value(s) (e.g., one or more of times A-D) and optionally the time difference between receiving pulse 302 in device 12-2 and sending pulse 304 from device 12-2 (block 224).

The delay computation circuitry 14 is configured to compute a clock connection delay in clock connection 32 and/or clock connection 34 based on time A, time D, and the time difference between receiving pulse 302 in device 12-2 and sending pulse 304 from device 12-2 (e.g., either computed by the delay computation circuitry 14 or received from device 12-2) (block 226). In other embodiments where the time difference between receiving pulse 302 in device 12-2 and sending pulse 304 from device 12-2 is a predetermined time delay, the delay computation circuitry 14 is configured to compute the clock connection delay based on time A, time D, and the predetermined time delay. In general, the clock connection delay in clock connection 32 and/or clock connection 34 may be computed based on half of: time D less time A less the delay in device 12-2 (between receiving pulse 302 in device 12-2 and sending pulse 304 to device 12-1, e.g., time C less time B).

In some embodiments, the clock connection delay can be measured or computed once (or a number of times and then averaged) and then one of the clock connections 32, 34 may be disconnected (e.g., clock connection 34). In some embodiments, both clock connections 32, 34 remain connected so that the computation of the clock connection delay may be repeated (block 228) by repeating the steps of blocks 204-226 intermittently in order to obtain updated values of the delay in clock connection 32 and/or clock connection 34. This way, the system 10 is able to track delay changes over time, such as changes due to equipment “aging” or temperature fluctuations. For example, the delay in the clock connection 32 and/or clock connection 34 may be computed every second, before every periodic PPS pulse used for clock synchronization, for example.

In some embodiments, whether or not both clock connections 32, 34 remain connected, the steps of blocks 204-226 are repeated multiple times and the delay computation circuitry 14 is configured to repeat the computation of the clock connection delay intermittently yielding multiple clock connection delay results based on other pulses sent by device 12-1 and device 12-2. The delay computation circuitry 14 is configured to compute an average of the multiple clock connection delay results (block 230). Computing an average of the multiple clock connection delay results may combat sampling noise and inaccuracies. For example, if the sampling resolution is 0.1 nanoseconds (100 picoseconds), repeating steps of blocks 204-226 ten times and averaging the result may lead to better accuracy than the 0.1 nanosecond sampling resolution. In some embodiments, the steps of blocks 204-226 may be repeated many times between the periodic nPPS pulses generated by nPPS output interface 20-1 for clock synchronization purposes, as described in more detail with reference to FIG. 4.

The clock synchronization circuitry 16 is configured to discipline the clock 22-1 of device 12-1 or clock 22-2 of device 12-2, responsively to a pulse received by device 12-1 or device 12-2, respectively, and the computed clock connection delay (block 232). For example, if device 12-1 sends a pulse 306 on the second to device 12-2 (at time E) according to clock 22-1 and pulse 306 is received by device 12-2 at time F (e.g., 12 nanoseconds after the round second according to the clock 12-2), the clock synchronization circuitry 16 is configured to compute a clock adjustment based on the computed delay in the clock connection 32 of X (e.g., 5 nanoseconds) so that the time maintained by clock 22-2 is adjusted (e.g., reduced) by F less X (e.g., 7 nanoseconds).

In embodiments, where device 12-1 is unable to send pulses on the fly, device 12-1 may send pulses on the second and use one or more of those pulses for pulse 302. In embodiments, where device 12-1 is unable to log time A, time A may be derived from time D by the delay computation circuitry 14 assuming that the delay in the clock connections 32, 34 is short enough. As previously mentioned, the software 18-1 may configure the nPPS output interface 20-1 to operate as stated above. In some embodiments, software 18-1 retrieves time D from memory 28-1, derives time A from time D, requests times B and C (or the time difference between times B and C) from software 18-2 unless the time difference between times B and C is predetermined and already known by software 18-1, and computes the delay in clock connection 32 and/or clock connection 34. In some embodiments, the software 18-2 provides times B and C (or the time difference between times B and C) to software 18-1 without being requested to do so by software 18-1.

In practice, some or all of these functions of the controller 30 may be combined in a single physical component or, alternatively, implemented using multiple physical components. These physical components may comprise hard-wired or programmable devices, or a combination of the two. In some embodiments, at least some of the functions of the controller 30 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 4, which is a second pulse flow diagram 400 showing pulses being sent in the system 10 of FIG. 1.

In some embodiments, the delay measurement pulses 302, 304 may be sent between the clock synchronization pulses 404. In some embodiments, the nPPS output interface 20-1 is configured to periodically send clock synchronization pulses 404 at a rate of n pulses per second to nPPS input interface 26-1 via clock connection 32, and send pulse 302 at time A between two of the clock synchronization pulses 404.

In some embodiments, multiple delay measurement pulses 402 (including pulse 302) may be sent in the time period between sending clock synchronization pulses 404. In this manner the multiple delay measurement pulses 402 may be used to provide multiple computations of delay in clock connection 32 or clock connection 34 and optionally averaged. Therefore, in some embodiments, nPPS output interface 20-1 is configured to periodically send clock synchronization pulses 404 at a rate of n pulses per second to nPPS input interface 26-2 via clock connection 32, and send, among (e.g., between) at least two of the clock synchronization pulses 404, delay measurement pulses 402, at a rate of m pulses per second (m being greater than n), the delay measurement pulses 402 being used to yield multiple clock connection delay results.

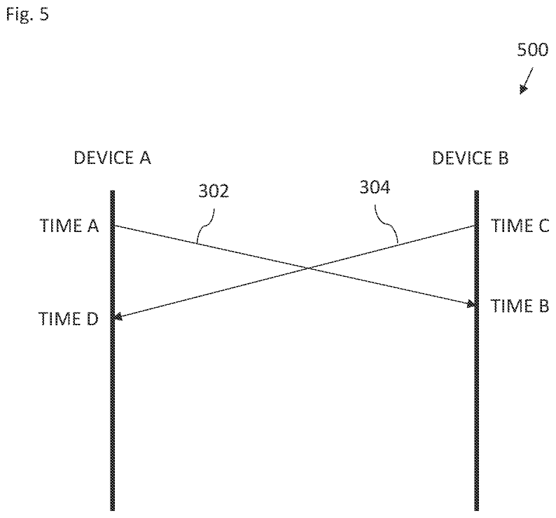

Reference is now made to FIG. 5, which is a third pulse flow diagram 500 showing pulses being sent in the system 10 of FIG. 1. In some embodiments, where both devices 12 cannot send pulses on the fly but only according to the periodic nPPS schedule (and do not include controller 30-1 or controller 30-2), the delay computation circuitry 14 may still compute the delay in the clock connection 32 and/or the clock connection 34 assuming the delay is below a given limit (e.g., much lower than 1 second). For example, pulse 302 may be sent by nPPS output interface 20-1 on the second, and pulse 304 may be send by nPPS output interface 20-2 on the second. Pulse 302 is sent at time A and received in device 12-2 at time B. Time A is generally not logged by device 12-1. Time B is logged by device 12-2 and nPPS input interface 26-2 sends an interrupt to software 18-2 reporting time B. Pulse 304 is sent at time C by device 12-2 and received in device 12-1 at time D. Therefore, in general, nPPS output interface 20-2 is configured to send pulse 304 at time C, which is before time B. Time C is generally not logged by device 12-2. Time D is logged by device 12-1 and nPPS input interface 26-1 sends an interrupt to software 18-1 reporting time D. Time C may be derived from time B, and time A may be derived from time D by the delay computation circuitry 14 as it is known that times A and C are round seconds according to their local clock. The delay computation circuitry 14 may receive the logged times and compute the clock connection delay in clock connection 32 and/or clock connection 34 based on half of: time D less time A less the delay in device 12-2 (between sending pulse 304 to device 12-1 and receiving pulse 302 in device 12-2 and, e.g., time C less time B). The above will extend the period between times B and C which can potentially impact the accuracy of the computed clock-connection delay.

The software 18-1 may enable nPPS input interface 26-1 to receive pulses and log time D, and enable nPPS output interface 20-1 to send a pulse every round second. The software 18-1 may communicate with software 18-2 to receive time B. The software 18-2 may enable nPPS input interface 26-2 to receive pulses and log time B, and enable nPPS output interface 20-2 to send a pulse every round second. The software 18-2 may communicate with software 18-1 to provide time B to software 18-2.

The above flow may be improved by using nPPS (n pulses per second instead of 1), thus reducing the expected value of time B less time C, as long as the delay in clock connection 32 or clock connection 34 and clock offset between clocks 22-1, 22-2 is much lower than 1/n seconds.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
a first device including:
a first clock to maintain a first clock time;
a first n-pulse-per-second (nPPS) output interface: to be connected to a second nPPS input interface of a second device via a first clock connection; and to send a first pulse at a time A to the second nPPS input interface for receipt by the second nPPS input interface at a time B; and
a first nPPS input interface: to be connected to a second nPPS output interface of the second device via a second clock connection; to receive a second pulse at a time D from the second nPPS output interface sent by the second nPPS output interface at a time C; and to log the time D in a first memory; and
delay computation circuitry to compute a clock connection delay in at least one of the first clock connection or the second clock connection based on the time A, the time D, and a time difference between receiving the first pulse in the second device and sending the second pulse from the second device.

2. The system according to claim 1, further comprising clock synchronization circuitry to discipline the first clock of the first device, or a second clock of the second device, responsively to a pulse received by the first device or the second device, respectively, and the computed clock connection delay.

3. The system according to claim 1, wherein the delay computation circuitry is to compute the time difference between receiving the first pulse in the second device and sending the second pulse from the second device based on the time B and the time C.

4. The system according to claim 1, wherein the time difference between receiving the first pulse in the second device and sending the second pulse from the second device is computed based on the time B and the time C, the delay computation circuitry being to receive the computed time difference from the second device.

5. The system according to claim 1, wherein the time difference between receiving the first pulse in the second device and sending the second pulse from the second device is a predetermined time delay based on a hardware configuration of the second device, the delay computation circuitry being to compute the clock connection delay based on the time A, the time D, and the predetermined time delay.

6. The system according to claim 5, wherein the predetermined time delay is equal to a single clock cycle of a controller of the second device.

7. The system according to claim 1, wherein the delay computation circuitry is to repeat the computation of the clock connection delay intermittently yielding multiple clock connection delay results based on other pulses sent by the first device and the second device.

8. The system according to claim 7, wherein the delay computation circuitry is to compute an average of the multiple clock connection delay results.

9. The system according to claim 1, wherein:
the first nPPS output interface is to periodically send clock synchronization pulses at a rate of n pulses per second to the second nPPS input interface via the first clock connection; and
the first nPPS output interface is to send, among at least two of the clock synchronization pulses, third pulses of the other pulses, at a rate of m pulses per second, used to yield the multiple clock connection delay results.

10. The system according to claim 1, wherein:
the first nPPS output interface is to periodically send clock synchronization pulses at a rate of n pulses per second to the second nPPS input interface via the first clock connection; and
the first nPPS output interface is to send the first pulse at the time A between two of the clock synchronization pulses.

11. The system according to claim 1, wherein the delay computation circuitry is to derive the time A from the time D.

12. The system according to claim 1, further comprising the first clock connection, the second clock connection, and the second device, wherein:
the second nPPS input interface is to: receive the first pulse at the time B; and log the time B in a second memory; and
the second nPPS output interface is to send the second pulse to the first device via the second clock connection.

13. The system according to claim 1, further comprising the second device, wherein:
the second nPPS input interface is to: receive the first pulse at the time B; and log the time B in a second memory;
the second device includes a controller to detect receipt of the first pulse and cause the second nPPS output interface to send the second pulse to the first device via the second clock connection in response to detecting the receipt of the first pulse; and
the second nPPS output interface is to log the time C in the second memory.

14. The system according to claim 13, wherein the controller is to minimize a difference between time B and time C.

15. The system according to claim 1, further comprising the second device, wherein:
the second nPPS input interface is to: receive the first pulse at the time B; and log the time B in a second memory; and
the second device includes a controller to detect receipt of the first pulse and cause the second nPPS output interface to send the second pulse to the first device via the second clock connection within a predetermined time delay of detecting the receipt of the first pulse.

16. The system according to claim 15, wherein the predetermined time delay is equal to a single clock cycle of the controller.

17. The system according to claim 1, further comprising the second device, wherein the second nPPS output interface is to send the second pulse at time C, which is before time B.

18. A system, comprising a second device including:
a second n-pulse-per-second (nPPS) input interface: to be connected to a first nPPS output interface of a first device via a first clock connection; to receive a first pulse at a time B from the first nPPS output interface sent by the first nPPS output interface at a time A; and to log the time B in a second memory;
a second nPPS output interface: to be connected to a first nPPS input interface of the first device via a second clock connection; and to send a second pulse at a time C to the first nPPS input interface for receipt by the first nPPS input interface at a time D; and
a controller to detect receipt of the first pulse and cause the second nPPS output interface to send the second pulse to the first device via the second clock connection in response to detecting the receipt of the first pulse.

19. The system according to claim 18, further comprising:
delay computation circuitry to compute a clock connection delay in at least one of the first clock connection or the second clock connection based on the time A, the time D, and a time difference between receiving the first pulse in the second device and sending the second pulse from the second device; and
clock synchronization circuitry to discipline a first clock of the first device, or a second clock of the second device, responsively to a pulse received by the first device or the second device, respectively, and the computed clock connection delay.

20. The system according to claim 19, wherein the delay computation circuitry is to compute the time difference between receiving the first pulse in the second device and sending the second pulse from the second device based on the time B and the time C.

21. The system according to claim 19, wherein the time difference between receiving the first pulse in the second device and sending the second pulse from the second device is computed based on the time B and the time C, the delay computation circuitry being to receive the computed time difference.

22. The system according to claim 18, wherein the controller is to cause the second nPPS output interface to send the second pulse to the first device via the second clock connection within a predetermined time delay of detecting the receipt of the first pulse.

23. The system according to claim 22, wherein the predetermined time delay is equal to a single clock cycle of the controller.

24. The system according to claim 18, wherein the controller is to minimize a difference between time B and time C.

25. A method, comprising:
connecting a first n-pulse-per-second (nPPS) output interface of a first device to a second nPPS input interface of a second device via a first clock connection;
connecting a first nPPS input interface of the first device to a second nPPS output interface of the second device via a second clock connection;
sending a first pulse at a time A from the first nPPS output interface to the second nPPS input interface for receipt by the second nPPS input interface at a time B;
receiving a second pulse at a time D by the first nPPS input interface from the second nPPS output interface sent by the second nPPS output interface at a time C;
logging the time D in a first memory; and
computing a clock connection delay in at least one of the first clock connection or the second clock connection based on the time A, the time D, and a time difference between receiving the first pulse in the second device and sending the second pulse from the second device.

26. A method, comprising:
connecting a first n-pulse-per-second (nPPS) output interface of a first device to a second nPPS input interface of a second device via a first clock connection;
connecting a first nPPS input interface of the first device to a second nPPS output interface of the second device via a second clock connection;
receiving by the second nPPS input interface a first pulse at a time B from the first nPPS output interface sent by the first nPPS output interface at a time A;
logging the time B in a second memory;
detecting receipt of the first pulse; and
causing the second nPPS output interface to send a second pulse to the first device via the second clock connection in response to detecting the receipt of the first pulse; and
sending the second pulse at a time C from the second nPPS output interface to the first nPPS input interface for receipt by the first nPPS input interface at a time D.
